(19) United States
(12) Patent Application Publication
(10) Pub. No.: US 2026/0361372 A1
(43) Pub. Date: Nov. 12, 2026

(54) WIRELESS COMMUNICATION SYSTEM, WIRELESS COMMUNICATION CONTROL METHOD, AND WIRELESS COMMUNICATION APPARATUS

(71) Applicant: NTT, Inc., Tokyo (JP)

(72) Inventors: Takuto ARAI, Musashino-shi (JP); Daisei UCHIDA, Musashino-shi (JP); Tatsuhiko IWAKUNI, Musashino-shi (JP); Shuki WAI, Musashino-shi (JP); Naoki KITA, Musashino-shi (JP)

(73) Assignee: NTT, Inc., Tokyo (JP)

(21) Appl. No.: 18/997,626

(22) PCT Filed: Jul. 26, 2022
(86) PCT No.: PCT/JP2022/028738

§ 371 Date: Jan. 22, 2025

(51) Int. Cl. H04B 7/06; H04B 17/318

(52) U.S. Cl. CPC H04B 7/06952; H04B 17/318

(57) ABSTRACT

A wireless communication system including: a first communication device; and a second communication device that communicates with the first communication device, in which the first communication device includes: a transmission/reception unit that controls a beam direction of a beam formed by a plurality of antenna elements by controlling at least phases or amplitudes of the plurality of antenna elements, and transmits a reference signal in each beam direction while changing the beam direction such that communication areas partially overlap each other between adjacent beams; and a beam control unit that acquires, from the second communication device, quality information regarding the beam obtained for each reference signal received by the second communication device, estimates an appropriate beam direction with respect to the second communication device on a basis of a weighted average of the acquired quality information of each reference signal, or a ratio of the quality information of adjacent beams and comparison of a gain ratio according to directions between adjacent beams, controls the transmission/reception unit such that a beam is formed in the estimated beam direction or a direction based on the estimated beam direction, and causes the transmission/reception unit and the second communication device to communicate with each other, and the second communication device acquires the quality information on a basis of a reference signal transmitted from the first communication device, and transmits the acquired quality information to the first communication device.

### TECHNICAL FIELD

The present invention relates to a wireless communication system, a wireless communication control method, and a wireless communication device.

### BACKGROUND ART

In a system such as 5th generation (5G), a high frequency band of a millimeter wave band is used. In order to implement higher speed and larger capacity in a future wireless communication system such as 6G, use of a higher frequency band capable of securing a wider bandwidth is assumed. While a propagation loss is large in a high frequency band, a wavelength is short, and thus it is assumed that a gain is secured by increasing the number of antenna elements and performing beamforming and a communication area (coverage) is covered. Assuming that a beamforming gain is obtained for a communication area, a beam search for estimating an appropriate beam direction is required in a state where connection is not yet made and an appropriate beam direction is unknown and in a disconnected state (at the time of initial connection).

FIG. 8 is a diagram illustrating an example of a beam search in 5G New Radio (NR). At the time of initial connection in the 5G NR, a wireless communication device 50 performs a beam sweep exhaustively within the coverage, and performs an all-search type beam search for selecting a beam having the highest received power in a wireless communication device 60 (see, for example, Non Patent Literature 1). In the example illustrated in FIG. 8, for example, a beam #2 is selected.

FIG. 9 is a diagram illustrating an example of a hierarchical beam search. The hierarchical beam search is a method of searching using beams having different beam widths depending on the stage. As illustrated in FIG. 9, the wireless communication device 50 performs a sweep using beams having a wide beam width (for example, beams #1-1, #1-2, and #1-3) in the first stage. In the second stage, the wireless communication device 50 performs a sweep using beams having a beam width narrower than the beam width used in the first stage (for example, beams #2-1 and #2-2) in the beam of the first stage included in the wireless communication device 60. A hierarchical beam search for reducing the number of beam searches in this way has also been proposed. In the hierarchical beam search, a beam search for the second stage can be performed individually for each user (for example, wireless communication device 60), or can be performed simultaneously for all users in multicast (see, for example, Non Patent Literature 2).

### CITATION LIST

### Non Patent Literature

Non Patent Literature 1: Takeda and others, “NR Physical Layer Specification in 5G”, NTT DOCOMO Technical Journal, Vol. 26, No. 3, pp. 47-58, November 2018.
Non Patent Literature 2: Kojima et al., “Study and experimental evaluation on 2-step beam search method in Millimeter-wave communications”, IEICE Technical Report, vol. 116, no. 396, RCS2016-237, pp. 7-11, January 2017.

### SUMMARY OF INVENTION

### Technical Problem

Since propagation attenuation increases as the frequency band is higher, it is necessary to increase a beamforming gain by narrowing the beam width. As a method of narrowing the beam width, it is conceivable to increase the antenna opening area by increasing the number of antenna elements, using a lens, or the like. On the other hand, if the beam width is narrowed, the directivity becomes strong, and the number of searches increases when a beam sweep covering a spatial area is performed, so that the overhead associated with the beam search increases. In a case where a hierarchical beam search is performed in order to reduce the overhead, the number of beam searches increases according to the number of users in a case where a beam search for the second stage is performed for each user. In a case where a beam search for the second stage is performed simultaneously for all users, it is necessary to exhaustively perform a beam search when the users are uniformly distributed within the coverage, and an effect of reducing the overhead required for the beam search is reduced.

In view of the above circumstances, an object of the present invention is to provide a technology capable of reducing an overhead related to a beam search as compared with a conventional technology in a base station 10 using a high frequency band.

### Solution to Problem

An aspect of the present invention is a wireless communication system including: a first communication device; and a second communication device that communicates with the first communication device, in which the first communication device includes: a transmission/reception unit that controls a beam direction of a beam formed by a plurality of antenna elements by controlling at least phases or amplitudes of the plurality of antenna elements, and transmits a reference signal in each beam direction while changing the beam direction such that communication areas partially overlap each other between adjacent beams; and a beam control unit that acquires, from the second communication device, quality information regarding the beam obtained for each reference signal received by the second communication device, estimates an appropriate beam direction with respect to the second communication device on a basis of a weighted average of the acquired quality information of each reference signal, or a ratio of the quality information of adjacent beams and comparison of a gain ratio according to directions between adjacent beams, controls the transmission/reception unit such that a beam is formed in the estimated beam direction or a direction based on the estimated beam direction, and causes the transmission/reception unit and the second communication device to communicate with each other, and the second communication device acquires the quality information on a basis of a reference signal transmitted from the first communication device, and transmits the acquired quality information to the first communication device.

An aspect of the present invention is a wireless communication control method performed by a wireless communication system including: a first communication device; and a second communication device that communicates with the first communication device, in which the first communication device controls a beam direction of a beam formed by a plurality of antenna elements by controlling at least phases or amplitudes of the plurality of antenna elements, transmits a reference signal in each beam direction while changing the beam direction such that communication areas partially overlap each other between adjacent beams, acquires, from the second communication device, quality information regarding the beam obtained for each reference signal received by the second communication device, estimates an appropriate beam direction with respect to the second communication device on a basis of a weighted average of the acquired quality information of each reference signal, or a ratio of the quality information of adjacent beams and comparison of a gain ratio according to directions between adjacent beams, performs control such that a beam is formed in the estimated beam direction or a direction based on the estimated beam direction, and causes communication, and the second communication device acquires the quality information on a basis of a reference signal transmitted from the first communication device, and transmits the acquired quality information to the first communication device.

An aspect of the present invention is a wireless communication device including: a transmission/reception unit that controls a beam direction of a beam formed by a plurality of antenna elements by controlling at least phases or amplitudes of the plurality of antenna elements, and transmits a reference signal in each beam direction while changing the beam direction such that communication areas partially overlap each other between adjacent beams; and a beam control unit that acquires, from an opposing device, quality information regarding the beam obtained for each reference signal received by the opposing device, estimates an appropriate beam direction with respect to the opposing device on a basis of a weighted average of the acquired quality information of each reference signal, or a ratio of the quality information of adjacent beams and comparison of a gain ratio according to directions between adjacent beams, controls the transmission/reception unit such that a beam is formed in the estimated beam direction or a direction based on the estimated beam direction, and causes the transmission/reception unit and the opposing device to communicate with each other.

### Advantageous Effects of Invention

According to the present invention, an overhead related to a beam search can be reduced as compared with a conventional technology in a base station 10 using a high frequency band.

### BRIEF DESCRIPTION OF DRAWINGS

FIG. 1 A diagram illustrating an example of a wireless communication system in an embodiment.

FIG. 2 A diagram illustrating a functional configuration example of a base station in the embodiment.

FIG. 3 A diagram illustrating a configuration example of a first beam control table in the embodiment.

FIG. 4 A diagram illustrating a configuration example of a second beam control table in the embodiment.

FIG. 5 A sequence diagram illustrating a flow of processing of the wireless communication system in the embodiment.

FIG. 6 A schematic diagram regarding beam direction selection in the embodiment.

FIG. 7 A schematic diagram of another example of beam direction selection in the embodiment.

FIG. 8 A diagram illustrating an example of a beam search in 5G New Radio (NR).

FIG. 9 A diagram illustrating an example of a hierarchical beam search.

### DESCRIPTION OF EMBODIMENTS

Hereinafter, an embodiment of the present invention will be described with reference to the drawings.

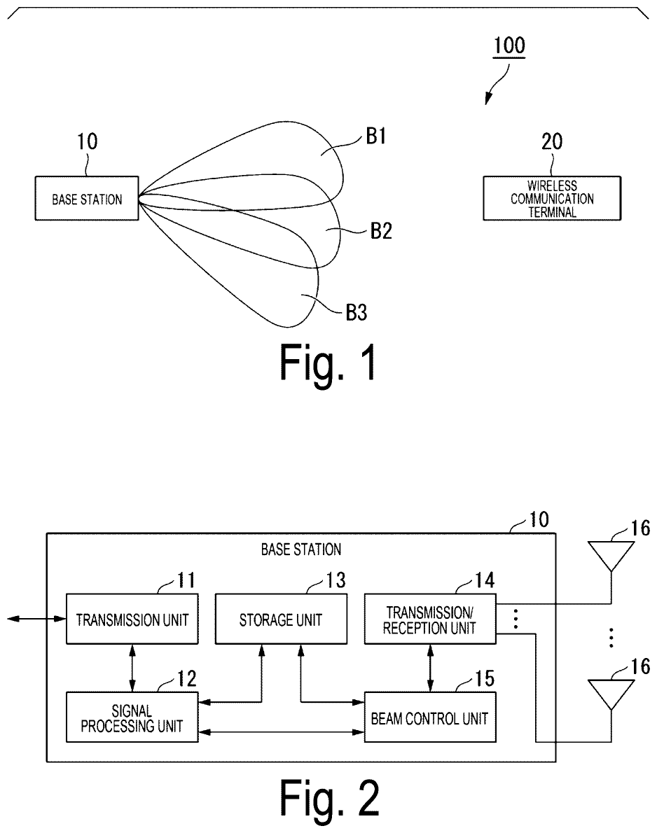

FIG. 1 is a diagram illustrating an example of a wireless communication system 100 in the embodiment. The wireless communication system 100 includes a base station 10 and a wireless communication terminal 20. Although FIG. 1 illustrates one base station 10 and one wireless communication terminal 20, the wireless communication system 100 may include a plurality of base stations 10 and a plurality of wireless communication terminals 20.

The base station 10 communicates with the wireless communication terminal 20 using a high frequency band such as a millimeter wave band. For example, the base station 10 sequentially forms a plurality of beams in different directions and transmits a reference signal for each of the beams. The beams formed by the base station 10 are beams having directivity in specific directions. In FIG. 1, three beams B1 to B3 are illustrated as beams formed by the base station 10. For example, the base station 10 sequentially forms the beams B1 to B3 and transmits a reference signal for each of the beams. The beams B1 to B3 have different directivity directions. Note that the number of beams formed by the base station 10 is not particularly limited to three.

The base station 10 performs beamforming by controlling at least the phases or amplitudes of a plurality of antenna elements. As illustrated in FIG. 1, the base station 10 transmits a reference signal in each beam direction while changing the beam direction such that communication areas partially overlap between adjacent beams (for example, beam B1 and beam B2, beam B2 and beam B3). Hereinafter, a method of transmitting a reference signal in each beam direction while changing the beam direction such that communication areas partially overlap between adjacent beams will be referred to as a beam sweep. In this manner, at the time of a beam sweep, the base station 10 performs a beam sweep using beams having a beam width expanded as in the first stage of a hierarchical beam search.

The base station 10 acquires, from the wireless communication terminal 20, quality information obtained for each reference signal received by the wireless communication terminal 20. The quality information is information regarding a beam formed by the base station 10, and includes, for example, a received signal intensity, a received signal intensity ratio between beams, a signal-to-noise power ratio, a connection distance, a reception timing, and the like. The base station 10 estimates an appropriate beam direction with respect to the wireless communication terminal 20 on the basis of the acquired quality information of each reference signal, and forms a beam in the estimated beam direction or a direction based on the estimated beam direction. The direction based on the estimated beam direction is a beam direction newly selected on the basis of the estimated beam direction. For example, the direction based on the estimated beam direction is a direction of a candidate beam to which the estimated beam direction is the closest among predetermined candidate beams. In this manner, the base station 10 selects a beam to be finally used without performing a beam search in the second stage of a hierarchical beam search.

The wireless communication terminal 20 communicates with the base station 10. The wireless communication terminal 20 receives a reference signal transmitted from the base station 10 for each beam by a beam sweep, and acquires quality information for each beam on the basis of the received reference signal. The wireless communication terminal 20 transmits a part of the acquired quality information for each beam to the base station 10. For example, the wireless communication terminal 20 transmits, of the acquired quality information for each beam, quality information from a beam having the highest received power to an adjacent beam of the beam having the highest received power or quality information of an adjacent beam pair having the highest total reception output to the base station 10. Note that the wireless communication terminal 20 may feed back information such as the orientation of the wireless communication terminal 20 in addition to the quality information acquired at the time of the beam sweep.

Note that, depending on the positional relationship between the base station 10 and the wireless communication terminal 20, the wireless communication terminal 20 may not be able to receive all reference signals transmitted by the base station 10 using each beam. Therefore, the wireless communication terminal 20 may transmit part of the quality information of the received reference signals to the base station 10 as described above.

FIG. 2 is a diagram illustrating a functional configuration example of the base station 10 in the embodiment. The base station 10 includes a transmission unit 11, a signal processing unit 12, a storage unit 13, a transmission/reception unit 14, a beam control unit 15, and a plurality of antennas 16.

The transmission unit 11 performs signal transmission with a host device on a network, another wireless communication device, or the like.

The signal processing unit 12 performs signal processing related to wireless communication.

The storage unit 13 stores information related to beam control processing. For example, the storage unit 13 stores a first beam control table and a second beam control table. The first beam control table is a table in which information regarding beams to be used at the time of a beam sweep is registered. In the first beam control table, quality information fed back from the wireless communication terminal 20 is associated with each beam direction of beams used at the time of a beam sweep. The second beam control table is a table in which information regarding beams to be used for the wireless communication terminal 20 is registered. In the second beam control table, information regarding beam directions of a plurality of candidate beams to be candidates of beams to be used for communication with the wireless communication terminal 20 is registered.

In accordance with an instruction from the beam control unit 15, the transmission/reception unit 14 controls at least the amplitudes or phases of the antennas 16 such that a plurality of beams is formed in different directions, sequentially switches the plurality of beams, and transmits a signal. The transmission/reception unit 14 receives quality information transmitted from the wireless communication terminal 20 via the antennas 16.

The beam control unit 15 instructs the transmission/reception unit 14 to control a beam formed by the antennas 16. Specifically, the beam control unit 15 acquires quality information regarding each beam in a beam sweep from the wireless communication terminal 20, and instructs the transmission/reception unit 14 to control a beam formed by the antennas 16 on the basis of the acquired quality information.

The plurality of antennas 16 forms a plurality of candidate beams in different directions according to control of the transmission/reception unit 14. The antennas 16 transmit a signal by radiating a radio wave using the formed candidate beams. The antennas 16 receive a radio wave transmitted from the wireless communication terminal 20 using the formed candidate beams.

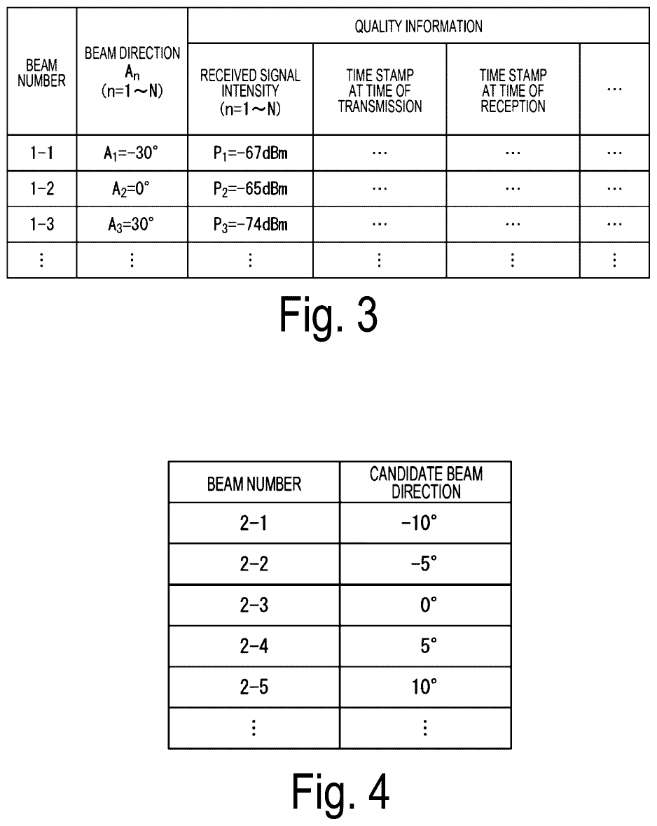

FIG. 3 is a diagram illustrating a configuration example of the first beam control table in the embodiment. As illustrated in FIG. 3, the first beam control table includes a plurality of records in which information regarding beams to be used at the time of a beam sweep is registered. Each of the records includes each value of a beam number, a beam direction An (n=1 to N), and quality information. The beam number registered in each of the records of the first beam control table represents information for identifying beams formed by the base station 10. The beam direction registered in each of the records of the first beam control table represents the direction (for example, angle) of beams formed by the base station 10. The quality information represents information obtained on the basis of a reference signal received by the wireless communication terminal 20. In FIG. 3, as an example of the quality information, information of a received signal intensity Pn, a time stamp at the time of transmission, and a time stamp at the time of reception is illustrated. Note that, in the first beam control table, quality information is not registered at the start of processing, and quality information regarding a beam direction in which the wireless communication terminal 20 cannot receive a reference signal after a beam sweep is not registered.

FIG. 4 is a diagram illustrating a configuration example of the second beam control table in the embodiment. As illustrated in FIG. 4, the second beam control table includes a plurality of records in which information regarding beams to be used for communication of the wireless communication terminal 20 is registered. Each of the records includes each value of a beam number and a candidate beam direction. The beam number registered in each of the records of the second beam control table represents information for identifying beams formed by the base station 10. The candidate beam direction registered in each of the records of the second beam control table represents a candidate of the direction (for example, angle) of beams formed by the base station 10.

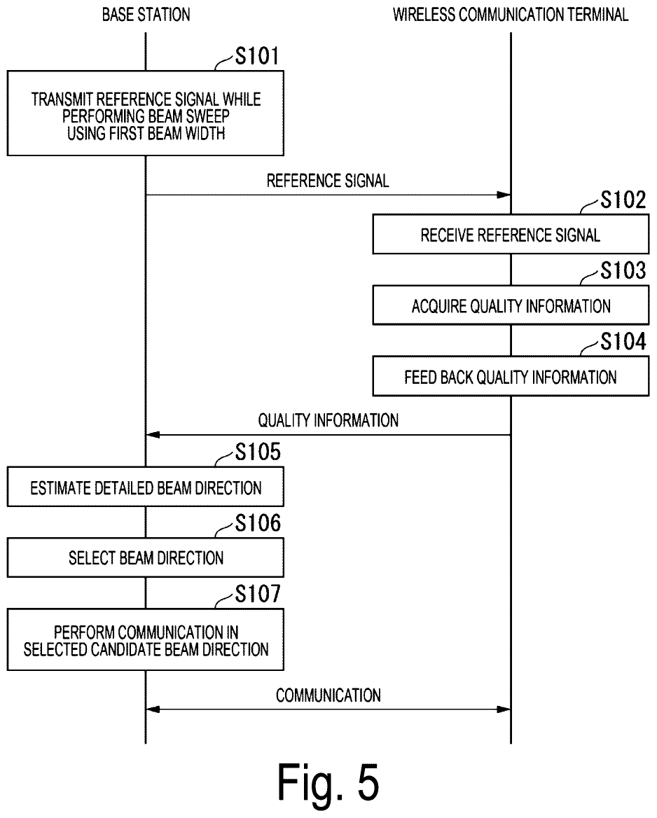

FIG. 5 is a sequence diagram illustrating a flow of processing performed by the wireless communication system 100 in the embodiment.

The beam control unit 15 of the base station 10 controls the transmission/reception unit 14 such that a reference signal is transmitted for each beam while performing a beam sweep using a first beam width (beam width enlarged as in the first stage of a hierarchical beam search). Specifically, the beam control unit 15 refers to the first beam control table stored in the storage unit 13, and controls the transmission/reception unit 14 such that a reference signal is transmitted in each beam direction while sequentially changing the beam direction indicated by each beam number. The transmission/reception unit 14 controls at least the amplitudes or phases of the antennas 16 according to control of the beam control unit 15, and transmits a reference signal in each beam direction while sequentially changing the beam direction indicated by each beam number (step S101).

The wireless communication terminal 20 receives the reference signal transmitted from the base station 10 (step S102). The wireless communication terminal 20 acquires quality information on the basis of the received reference signal (step S103). The wireless communication terminal 20 executes the processing from step S102 to step S103 every time a reference signal transmitted from the base station 10 is received. The wireless communication terminal 20 feeds back the acquired quality information to the base station 10 (step S104). Note that the wireless communication terminal 20 may not feed back quality information of all received reference signals to the base station 10. For example, the wireless communication terminal 20 may feed back quality information related to some of received reference signals to the base station 10. Note that the wireless communication terminal 20 may perform feedback including information such as a beam ID for identifying a beam as feedback information, or may identify a beam according to a feedback timing or the like.

The transmission/reception unit 14 of the base station 10 receives the quality information transmitted from the wireless communication terminal 20 via the antennas 16. The transmission/reception unit 14 outputs the received quality information to the beam control unit 15. The beam control unit 15 registers the quality information output from the transmission/reception unit 14 in the first beam control table in association with a beam number. For example, after causing transmission of a reference signal in a beam direction A₁ (for example, −30°) indicated by a beam number 1-1, the beam control unit 15 registers quality information obtained during a predetermined period in the first beam control table in association with the beam number 1-1. In this manner, the beam control unit 15 registers quality information in each beam direction in the first beam control table.

After the end of the beam sweep, the beam control unit 15 estimates a detailed beam direction on the basis of the quality information of each beam direction registered in the first beam control table (step S105). Specifically, first, the beam control unit 15 selects a beam direction having the highest received signal intensity from the quality information of each beam direction registered in the first beam control table. Next, the beam control unit 15 refers to received signal intensities in a plurality of beams adjacent to a beam identified by the selected beam direction and takes a weighted average of beam directions based on the received signal intensities, thereby estimating a more detailed beam direction in the beam identified in the selected beam direction. For example, the beam control unit 15 estimates a more detailed beam direction on the basis of the following Formula (1). Note that, in Formula (1), An represents a beam direction in which the base station 10 emits a beam by a beam sweep, and Pn represents a received signal intensity in each beam direction.

$$\begin{matrix}[ Math . 1 ] & \\ \frac{{\sum }_{n = 1}^{N} {A}_{n} {X}_{n}}{{\sum }_{n = 1}^{N} {X}_{n}} Here , {X}_{n} = {10}^{( \frac{{P}_{n}}{10} )} is defined . & Formula ( 1 )\end{matrix}$$

In a description using FIG. 3 as an example, first, the beam control unit 15 selects a beam direction A₂ having the highest received signal intensity from the quality information of each beam direction registered in the first beam control table. Next, the beam control unit 15 calculates a weighted average of the received signal intensity of a beam number 1-2 identified in the selected beam direction A₂ and the received signal intensities of a plurality of beam numbers 1-1 and 1-3 adjacent to the beam number 1-2 identified in the selected beam direction A₂ on the basis of the above Formula (1). Here, N=3 is satisfied. Accordingly, “−8.6°” is calculated. Therefore, the beam control unit 15 estimates a more detailed beam direction in the beam identified by the selected beam direction as “−8.6°”.

Note that, although the configuration has been described in the above example in which the weighted average is calculated using received signal intensities of a plurality of beams adjacent to a beam identified in a selected beam direction, the beam control unit 15 may perform weighted average using received signal intensities of a plurality of adjacent beams in both directions of the beam identified in the selected beam direction (for example, a plurality of beams adjacent to the beam identified in the selected beam direction and a plurality of beams further adjacent to the plurality of adjacent beams). In this case, N=5 is satisfied in Formula (1).

In a case where the beam direction selected by the beam control unit 15 is either end (for example, beam number 1-1, 1-3, or the like in a case of beam numbers 1-1 to 1-3), there is only one adjacent beam. In such a case, the beam control unit 15 may perform a beam search in the second stage in a hierarchical beam search within a range of the selected beam direction, or may perform a search with the beam width near the either end narrowed.

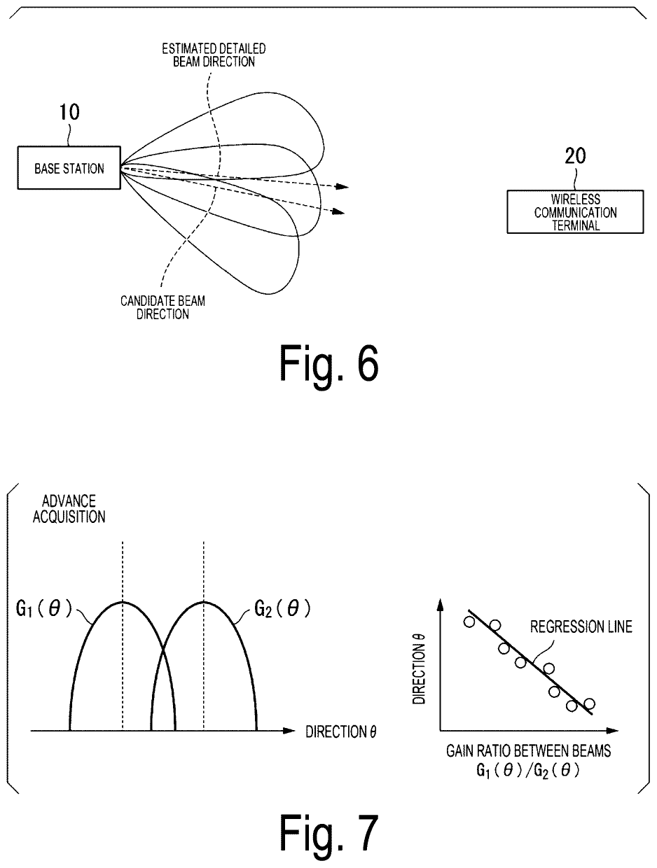

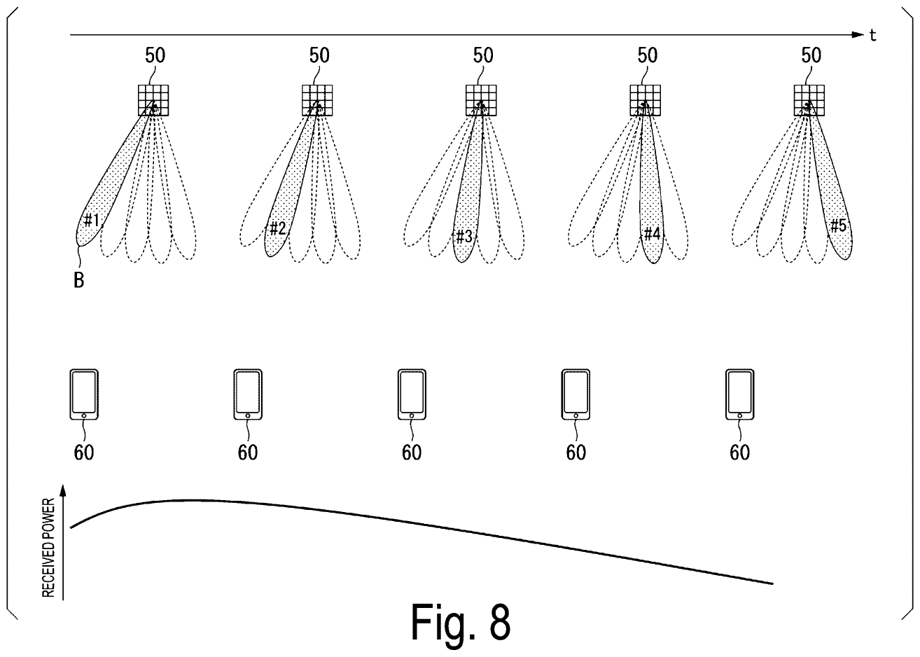

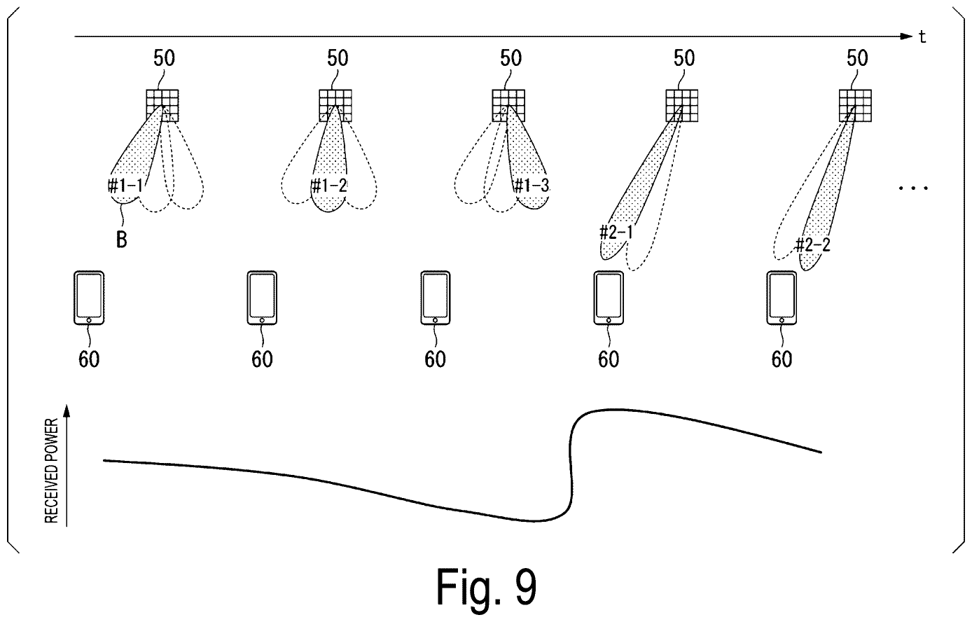

Thereafter, the beam control unit 15 refers to the second beam control table, and selects a candidate beam direction closest to the estimated beam direction among candidate beam directions registered in the second beam control table (step S106). For example, the beam control unit 15 refers to the second beam control table, and selects “−10°” that is closest to the estimated beam direction “−8.6°” as a candidate beam direction used for communication with the wireless communication terminal 20. FIG. 6 is a schematic diagram of the above-described processing. The beam control unit 15 controls the transmission/reception unit 14 such that a beam is formed in the selected candidate beam direction. The transmission/reception unit 14 controls at least the amplitudes or phases of the antennas 16 according to control of the beam control unit 15 such that a beam is formed in the candidate beam direction. Then, the base station 10 performs data communication with the wireless communication terminal 20 using the formed beam (step S107).

Note that, in the above-described example, the beam control unit 15 selects a candidate beam direction closest to the estimated beam direction, but may select the estimated beam direction as a beam direction used for communication with the wireless communication terminal 20. In this case, the beam control unit 15 controls the transmission/reception unit 14 such that a beam is formed in the selected beam direction (estimated beam direction). The transmission/reception unit 14 controls at least the amplitudes ore phases of the antennas 16 according to control of the beam control unit 15 such that a beam is formed in a beam direction (estimated beam direction).

According to the wireless communication system 100 configured as described above, an overhead related to a beam search can be reduced as compared with the conventional technology in the base station 10 using a high frequency band. Specifically, the base station 10 includes the transmission/reception unit 14 that controls a beam direction of a beam formed by the plurality of antennas 16 by controlling at least the phases or amplitudes of the plurality of antennas 16, and transmits a reference signal in each beam direction while changing the beam direction such that communication areas partially overlap each other between adjacent beams, and the beam control unit 15 that acquires quality information regarding a beam obtained for each reference signal received by the wireless communication terminal 20 from the wireless communication terminal 20, estimates an estimation beam direction regarded as a direction in which the wireless communication terminal 20 is located on the basis of a weighted average of the acquired quality information of each reference signal, and controls the transmission/reception unit 14 such that a beam is formed in the estimated estimation beam direction or a direction based on the estimated estimation beam direction (candidate beam direction). With such a configuration, a beam search in the second stage is not performed. Therefore, an overhead related to a beam search can be reduced as compared with the conventional technology.

Hereinafter, modifications in the wireless communication system 100 will be described.

### (Modification 1)

Functional units included in the base station 10 may be divided into a centralized unit (CU), a distributed unit (DU), and a radio unit (RU) in 5G New Radio (NR) and disposed. In such a configuration, for example, the transmission unit 11 is disposed in the CU, the signal processing unit 12 is disposed in the DU, and the storage unit 13, the transmission/reception unit 14, and the beam control unit 15 are disposed in the RU.

### (Modification 2)

In a case where the wireless communication system 100 includes a plurality of base stations 10, the plurality of base stations 10 may be connected via a network, and each of the base stations 10 may share information fed back from the wireless communication terminal 20. In such a configuration, each of the base stations 10 may perform beam control by estimating the position of the wireless communication terminal 20 in cooperation with other base stations 10, for example, on the basis of a combination of a received signal intensity in each beam direction of each of the base stations 10, a connection distance, a reception timing, and the like.

### (Modification 3)

Machine learning may be used as a more detailed beam direction estimation method using quality information obtained as a result of a beam sweep. In such a configuration, a learning period for performing machine learning may be provided before operation or during operation.

### (Modification 4)

A beam candidate may be selected from among three-dimensional beam candidates including estimation of not only the azimuth direction but also the elevation angle direction.

### (Modification 5)

Although the configuration in the downlink from the base station 10 to the wireless communication terminal 20 has been described in the above embodiment, the above-described beam search method is also applicable to the uplink from the wireless communication terminal 20 to the base station 10. In a case of application to the uplink, the wireless communication terminal 20 performs a beam search by a method similar to the processing performed by the base station 10. In this case, the wireless communication terminal 20 includes the storage unit 13 and the beam control unit 15 included in the base station 10.

### (Modification 6)

Although the beam search has been described in the above embodiment, index selection or the like in codebook-based multiple-input and multiple-output (MIMO) may be applied as wireless control according to the present invention.

### (Modification 7)

In the above embodiment, the configuration has been described in which the beam control unit 15 estimates a more detailed beam direction in a beam identified by a selected beam direction on the basis of a weighted average of quality information. The beam control unit 15 may be configured to estimate a more detailed beam direction in a beam identified by a selected beam direction on the basis of a ratio of quality information of the adjacent beams and comparison of a gain ratio according to the directions between the adjacent beams. In such a configuration, for example, as illustrated in (A) and (B) of FIG. 7, gain ratios according to directions between adjacent beams are acquired in advance by calculation or actual measurement. This is performed in advance for all beams in beam directions in which the base station 10 performs a beam sweep. For example, a gain ratio G₁/G₂ of a gain G₁ in the beam direction A₁ and a gain G₂ in the beam direction A₂, and a gain ratio G₂/G₃ of the gain G₂ in the beam direction A₂ and a gain G₃ in a beam direction A₃ are acquired by calculation or actual measurement. This information is stored in the storage unit 13. The beam control unit 15 refers to a ratio between the received signal intensity of a beam selected in the first stage and the received signal intensity of a beam having a higher received signal intensity of the adjacent beams, and estimates a more detailed beam direction on the basis of the gain ratio according to the directions acquired in advance. For example, the beam control unit 15 estimates a more detailed beam direction on the basis of the following Formula (2).

$$\begin{matrix}[ Math . 2 ] & \\ θ = aR + b & Formula ( 2 )\end{matrix}$$

$$R = \frac{{G}_{1} ( θ )}{{G}_{2} ( θ )}$$

$$a = \frac{{\sum }_{n = 1}^{N} ( {R}_{n} - \overline{R} ) ( {θ}_{n} - \overline{θ} )}{{\sum }_{n = 1}^{N} ( {R}_{n} - \overline{R} )}$$

$$b = \overline{θ} - aR$$

The relationship of received power and beam directions between beams is more accurately represented as compared to a case of a weighted average by a more detailed beam direction being estimated on the basis of a gain ratio as described above, and accordingly, improvement in accuracy can be expected in an environment with few multipaths. Furthermore, less information needs to be fed back from the wireless communication terminal 20. For example, in a case of a weighted average, received power information corresponding to the number of beams to be averaged is required, whereas in estimation of a beam direction based on a gain ratio, information can be aggregated into one piece of information as information of a ratio between two beams. Furthermore, in a case where the number of beams to be subjected to weighted average is three or more, the beam range in which estimation is performed is narrower than a weighted average, and thus, the risk of large deviation can be reduced.

(Correspondence with Claims)

The base station 10 is an aspect of a first communication device, a second communication device, and a wireless communication device. The wireless communication terminal 20 is an aspect of the first communication device, the second communication device, and the wireless communication device. In a case where the base station 10 is the first communication device, the wireless communication terminal 20 is the second communication device, and in a case where the base station 10 is the second communication device, the wireless communication terminal 20 is the first communication device.

Some or all of the functional units of the base station 10 and the wireless communication terminal 20 in the above-described embodiment are implemented as software by one or more processors such as a central processing unit (CPU) executing a program stored in a storage device including a non-volatile recording medium (non-transitory recording medium) and a memory. The program may be recorded in a computer-readable non-transitory recording medium. The computer-readable non-transitory recording medium is a non-transitory recording medium, for example, a portable medium such as a flexible disk, a magneto-optical disk, a read only memory (ROM), or a compact disc ROM (CD-ROM), or a storage device such as a hard disk built in a computer system.

Some or all of the functional units of the base station 10 and the wireless communication terminal 20 may be implemented by using, for example, hardware including an electronic circuit (or circuitry) using a large scale integrated circuit (LSI), an application specific integrated circuit (ASIC), a programmable logic device (PLD), a field programmable gate array (FPGA), or the like.

Although the embodiment of this invention has been described in detail with reference to the drawings, the specific configuration is not limited to the embodiment, and includes design and the like within a range not departing from the gist of this invention.

### INDUSTRIAL APPLICABILITY

The present invention can be applied to a wireless communication system that performs beamforming.

### REFERENCE SIGNS LIST

10 Base station
20 Wireless communication terminal
11 Transmission unit
12 Signal processing unit
13 Storage unit
14 Transmission/reception unit
15 Beam control unit
16 Antenna

1. A wireless communication system comprising: a first communication device; and a second communication device that communicates with the first communication device,
wherein the first communication device includes:
a tranceiver configured to control a beam direction of a beam formed by a plurality of antenna elements by controlling at least phases or amplitudes of the plurality of antenna elements, and transmits a reference signal in each beam direction while changing the beam direction such that communication areas partially overlap each other between adjacent beams; and
a beam controller configured to acquire, from the second communication device, quality information regarding the beam obtained for each reference signal received by the second communication device, estimates an appropriate beam direction with respect to the second communication device on a basis of a weighted average of the acquired quality information of each reference signal, or a ratio of the quality information of adjacent beams and comparison of a gain ratio according to directions between adjacent beams, controls the tranceiver such that a beam is formed in the estimated beam direction or a direction based on the estimated beam direction, and causes the tranceiver and the second communication device to communicate with each other, and
the second communication device
acquires the quality information on a basis of a reference signal transmitted from the first communication device, and transmits the acquired quality information to the first communication device.

2. The wireless communication system according to claim 1,
wherein the beam controller selects a candidate beam in a direction closest to the estimated beam direction from among a plurality of predetermined candidate beams, controls the tranceiver such that a beam is formed in a direction of a selected candidate beam, and causes the tranceiver and the second communication device to communicate with each other.

3. A wireless communication control method performed by a wireless communication system including: a first communication device; and a second communication device that communicates with the first communication device,
wherein the first communication device
controls a beam direction of a beam formed by a plurality of antenna elements by controlling at least phases or amplitudes of the plurality of antenna elements,
transmits a reference signal in each beam direction while changing the beam direction such that communication areas partially overlap each other between adjacent beams,
acquires, from the second communication device, quality information regarding the beam obtained for each reference signal received by the second communication device,
estimates an appropriate beam direction with respect to the second communication device on a basis of a weighted average of the acquired quality information of each reference signal, or a ratio of the quality information of adjacent beams and comparison of a gain ratio according to directions between adjacent beams,
performs control such that a beam is formed in the estimated beam direction or a direction based on the estimated beam direction, and causes communication, and
the second communication device
acquires the quality information on a basis of a reference signal transmitted from the first communication device, and
transmits the acquired quality information to the first communication device.

4. A wireless communication device comprising:
a tranceiver configured to control a beam direction of a beam formed by a plurality of antenna elements by controlling at least phases or amplitudes of the plurality of antenna elements, and transmits a reference signal in each beam direction while changing the beam direction such that communication areas partially overlap each other between adjacent beams; and
a beam controller configured to acquire, from an opposing device, quality information regarding the beam obtained for each reference signal received by the opposing device, estimates an appropriate beam direction with respect to the opposing device on a basis of a weighted average of the acquired quality information of each reference signal, or a ratio of the quality information of adjacent beams and comparison of a gain ratio according to directions between adjacent beams, controls the tranceiver such that a beam is formed in the estimated beam direction or a direction based on the estimated beam direction, and causes the tranceiver and the opposing device to communicate with each other.
